(19) United States
(12) Patent Application Publication
(10) Pub. No.: US 2024/0395422 A1
(43) Pub. Date: Nov. 28, 2024

(54) SYSTEMS, METHODS, AND DEVICES FOR AMPLIFYING LASER FOR NUCLEAR FUSION REACTIONS

(71) Applicant: Syntharise Chemical Inc., Omemee (CA)

(72) Inventor: Michael V. Lastoria, Omemee (CA)

(21) Appl. No.: 18/202,426

(22) Filed: May 26, 2023

(30) Foreign Application Priority Data
Apr. 17, 2023 (CA) 3197225

(51) Int. Cl. G21B 1/23; G21B 1/17

(52) U.S. Cl. CPC G21B 1/23; G21B 1/17

(57) ABSTRACT

Embodiments described herein provide a system and method for amplifying a laser beam, including: at least one laser source configured to provide the laser beam; and a rhombic prism configured to reflect the laser beam to a first mirror at a first angle, to a second mirror through an intersection point, to a third mirror configured to reflect the laser beam to the rhombic prism through the intersection point, the rhombic prism configured to reflect the laser beam to the first mirror at the angle. Multiple systems can be combined to reflect multiple lasers through the intersection point.

### FIELD

The present specification relates generally to lasers, and, in particular, to a system that amplifies laser for nuclear fusion reactions.

### BACKGROUND

A nuclear fusion reaction involves the merging of two atomic nuclei to form a single heavier, atomic nucleus, which is lighter than the sum of the mass of the two atomic nuclei. The formation of the heavier atomic nucleus releases energy. The difference between the mass of the single heavier atomic nucleus and the sum of the masses of the two atomic nuclei is equivalent to the energy released, which subsequently, may be harnessed to generate electricity. In order for a nuclear fusion reaction to occur, there must be, amongst other factors, sufficient pressure and temperature. Nuclear fusion reactions can be accomplished by a variety of means including the use of fuel and use of Light Amplification Stimulated Emission Radiation (LASER) (“laser”) devices.

Laser devices produce laser beams that are monochromatic, coherent and collimated. In order to support a nuclear fusion reaction, a laser beam should generate a high enough temperature. Consequently, having a high wattage laser beam may be necessary. However, high wattage laser beams are not cost effective.

### SUMMARY

In accordance with an aspect, a system for amplifying a laser beam, includes: at least one laser source configured to provide the laser beam; and a rhombic prism configured to reflect the laser beam to a first mirror at a first angle, the first mirror configured to reflect the laser beam to a second mirror through an intersection point, the second mirror configured to reflect the laser beam to a third mirror, the third mirror configured to reflect the laser beam to the rhombic prism through the intersection point, the rhombic prism configured to reflect the laser beam to the first mirror at the angle. In some embodiments, the laser beam is reflected in a continuous pattern. In some embodiments, one laser beam is included per system and any efficiency leak that occurs is a second split beam to be collected.

In some embodiments, the system further includes at least one material positioned at the intersection point for a fusion reaction. If more than one system is required to achieve fusion, additional systems are combined.

In some embodiments, the at least one material includes samarium, lanthanum, 2 moles of sulfur, and/or sulfur as metal sulfides that can be adjusted as a filament is introduced continuously. In some embodiments, material formed from fusion can be elements from francium to element 119, down group one of the periodic table, etc.

In some embodiments, the at least one material includes samarium, lanthanum, sulfur, or any combination thereof.

In some embodiments, the laser beam includes an IR wavelength such as 1064 nanometers. In some embodiments, the laser beam has a wavelength that is adjustable by nanometer. For example, nanometer wavelength adjustment of an IR laser type is included in some embodiments.

In some embodiments, the rhombic prism includes a coating of dielectric silver or silver-gold.

In some embodiments, the first mirror, the second mirror, and the third mirror each includes tungsten cooled with helium, silver, dielectric silver, or silver-gold.

In some embodiments, the system operates under a vacuum.

In some embodiments, the system further includes at least one additional mirror, each additional mirror positioned to reflect at least a part of the laser to the intersection point.

In some embodiments, the system further includes at least one additional mirror, each additional mirror positioned to reflect an efficiency leak of a reflected split beam originating from the laser beam to the intersection point.

In some embodiments, two or more systems are provided, each laser beam configured to intersect at the intersection point.

In accordance with an aspect, a system for amplifying a laser beam includes: a rhombic prism and at least three mirrors, each configured to reflect the laser beam in a repeating pattern through an intersection point, the intersection point having a temperature above a threshold temperature, the threshold temperature conducive for a fusion reaction.

In some embodiments, the repeating pattern is shaped as a figure eight.

In accordance with an aspect, a method for amplifying a laser beam includes: providing the laser beam; and reflecting the laser beam in a repeating pattern through an intersection point, the intersection point having a temperature above a threshold temperature, the threshold temperature conducive for at least one fusion reaction.

In some embodiments, the method further includes positioning at least one material at the intersection point for the at least one fusion reaction.

In some embodiments, the method further includes positioning at least one material at the intersection point for a fusion reaction.

In some embodiments, the laser beam has a wavelength of 1064 nanometers.

In some embodiments, the method further includes adjusting a wavelength of the laser beam.

In some embodiments, the method further includes reflecting laser from the laser beam through the intersection point.

In some embodiments, the method further includes maintaining the system under a vacuum.

In some embodiments, the method further includes providing at least one additional laser beam and reflecting each of the at least one additional laser beams in an additional repeating pattern through the intersection point.

In some embodiments, the method further includes using a variable number of intersecting laser systems and concentrating all of the individual system's intersection points, forming one intersection point to be utilized for fusion.

In some embodiments, the method further includes conducting at least one fusion reaction at the intersection point.

Other aspects and features according to the present application will become apparent to those ordinarily skilled in the art upon review of the following description of embodiments of the invention in conjunction with the accompanying figures.

### BRIEF DESCRIPTION

The principles of the invention may better be understood with reference to the accompanying figures provided by way of illustration of an exemplary embodiment, or embodiments, incorporating principles and aspects, and in which:

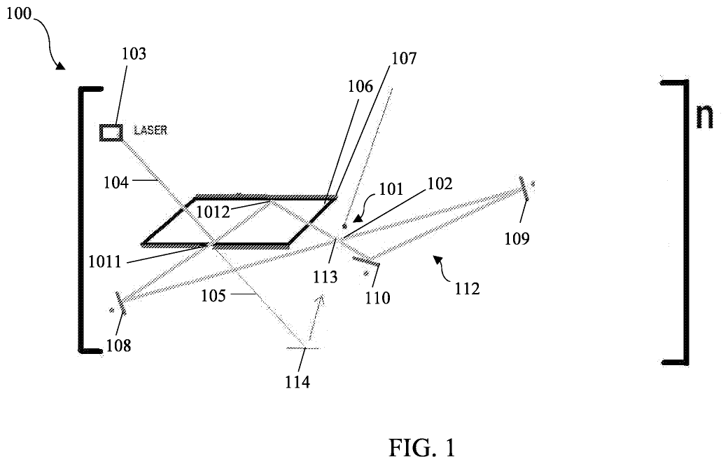

FIG. 1 is a schematic view of a system that amplifies laser, according to some embodiments;

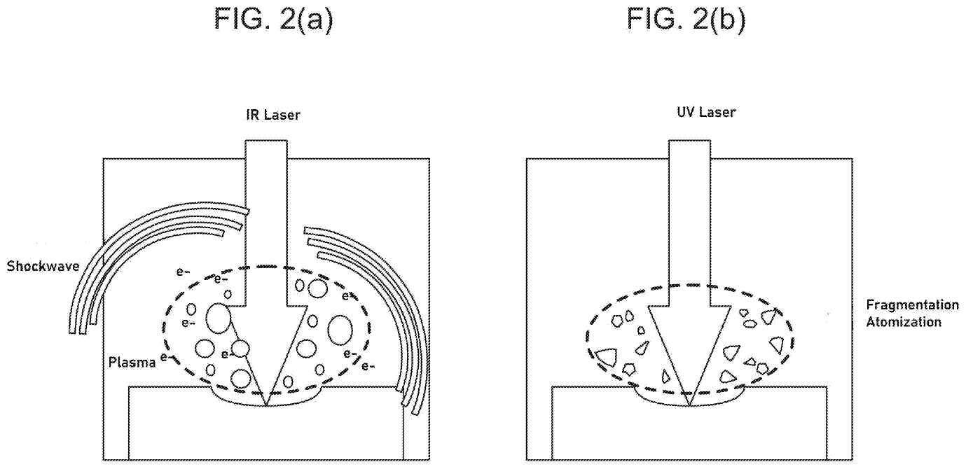

FIGS. 2(a) and (b) are schematic views of Infrared (IR) and Ultraviolet (UV) laser ablation of palladium (Pd); and

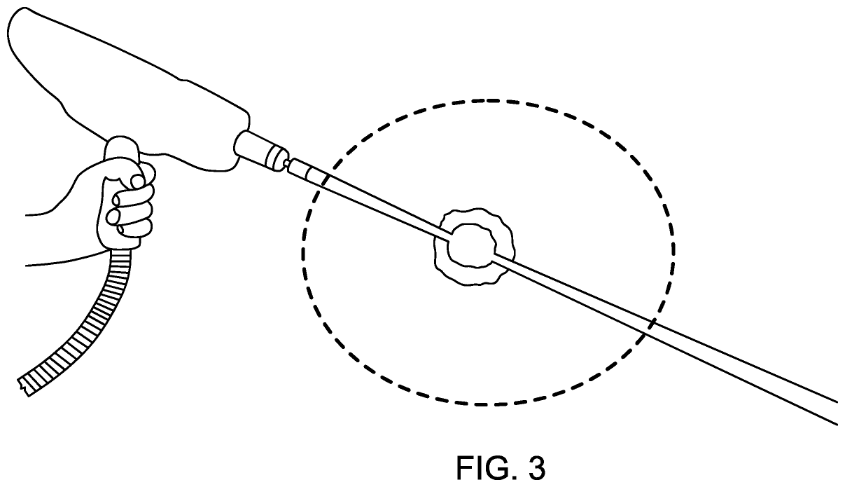

FIG. 3 is a perspective view of a single path laser device showing an intersecting laser and its combustion of air in a density point before spreading out again.

### DETAILED DESCRIPTION OF EMBODIMENTS

The description that follows, and the embodiments described therein, are provided by way of illustration of an example, or examples, of particular embodiments of principles of embodiments. These examples are provided for the purposes of explanation, and not of limitation, of those principles. In the description, like parts are marked throughout the specification and the drawings with the same respective reference numerals. The drawings are not necessarily to scale and in some instances, proportions may have been exaggerated in order more clearly to depict certain features.

In accordance with some embodiments, with more than one system, the material for fusion can be surrounded by the intersection points of more than one system, such as shown in FIG. 1, which shows a variable number of systems n that can be used as desired.

In some embodiments, system 100 is configured to provide a more efficient process of limiting power input to energy produced by amplifying a laser and directing the laser beam back onto itself or a path that it has travelled. System 100 can be used in space where there is a vacuum. This can provide a more efficient process for producing fusion at a higher efficiency and continuously. Energy can then be collected from system 100 efficiently (e.g., with less photon loss). For example, in some embodiments, system(s) 100 are configured to tune laser(s) 103 to produce a hot enough intersection point where fusion can run continuously to be able to be utilized for energy generation. System 100 can provide a means to use a lower amount of power to produce fusion. An intersection point of the laser can be configured and directed as desired. An example use case of system 100 is at a space engine where material is inputted at an intersection point of the laser for fusion. In some embodiments, system 100 allows efficient amplification of a laser using a rhombic prism, so as to use less power input, by directing the beam back around as efficiently as possible onto itself using high efficiency mirrors to intersect at desired intersection point at which material is positioned to allow a fusion reaction to occur. In some embodiments, the mirrors and rhombic prism are comprised of dielectric Ag/Au coating, and the laser has a 1064 nm wavelength and/or at as high power as possible without causing impermissible damage to components of system 100. For example, lasers 103 can be configured to be at the highest wattage for the greatest efficiency (e.g., just before the lasers would damage the components) for fewer systems 100 to be used to create the intersection point while producing an intersection point above a threshold temperature, such as suitable for facilitating fusion reactions. Other example materials for the mirrors include tungsten (highest melting point metal), silver, mirror with dielectric coating of silver or silver with gold. Other example materials for the rhombic prism include optical sapphire. In some embodiments, the mirrors can be comprised of tungsten (highest melting point metal), silver, mirror with dielectric coating of silver or silver with gold, while the rhombic prism is made of optical sapphire.

In some embodiments, system(s) 100 provide a device for amplifying a laser beam outside of itself, such that a lower wattage can be used to achieve not only continuous beams for constant fusion instead of pulses, but also provide a more cost effective system and less power input for the power output achieved.

According to some embodiments as shown in FIG. 1, a system 100 is configured to manage a laser 103. System 100 is configured to amplify the laser 103 for nuclear fusion reaction(s) 101, according to some embodiments. System 100 is under vacuum and acts to contain fusion plasma 102. System 100 can be maintained under vacuum and a fusion superconductor plasma containment, according to some embodiments. System 100 includes a laser 103 that produces laser beam 104 of a sufficient energy. The energy level can be configured as desired. A level of sufficient energy is determined based a number of factors such as the amount of energy required for a particular nuclear fusion reaction and the maximum amount of energy system 100 is able to withstand before disintegrating physically. In some embodiments, the wavelength of laser beam 104 is 1064 nanometers (nm). In some embodiments, one or more systems 100 are arranged, such as configured in conjunction with each other, such that one or more laser beams 104 produced by the one or more systems 100 intersect at one or more of the same intersection points. For example, according to some embodiments, more than one systems 100 can be combined such that each laser beam produced by each of the systems 100 intersect at a single intersection point. In some embodiments, the intersection point can be a combusting intersection point, where one or more materials are combusted at the intersection point. With more than one system, the material for fusion can be surrounded by the intersection points of more than one system, showing a variable number of systems that can be used as desired. In some embodiments, the method further includes using a variable number intersecting laser systems and concentrating all of the individual systems' intersection points, forming one intersection point to be utilized for fusion.

In some embodiments, laser beam 104 is amplified by coming back around on itself as many times and/or as efficiently as desired (such as to achieve fusion). An example embodiment of system 100 directing an example laser beam 104 will now be described according to some embodiments. Laser beam 104 travels towards a rhombic prism 106. Rhombic prism 106 is comprised of suitable material such as optical sapphire, which has a coating 107 made of either dielectric silver or silver-gold. Upon hitting the rhombic prism 106, the laser beam 104 is displaced or reflected at a point 1011, and consequently the laser beam 104 travels towards the mirrors 108, 109, 110. In some embodiments, mirrors 108, 109, 110 are comprised of tungsten cooled with helium (which has a high melting point) or other suitable material such as silver or dielectric silver coating or silver-gold. Mirrors 108, 109, 110 are positioned at a suitable angle such that laser beam 104 is reflected by mirrors 108, 109, 110 and consequently, travel in a path at least somewhat shaped like a figure eight 112. In particular, laser beam 104 is displaced by the rhombic prism at a point 1011 and travels towards the first mirror 108. Consequently, laser beam 104 is reflected by the first mirror 108 and travels towards the second mirror 109. Once reflected by the second mirror 109, the laser beam 104 travels towards the third mirror 110. Next, laser beam 104 is reflected by the third mirror 110 and travels towards the rhombic prism 106 and is displaced at a point 1012 and at the point 1011, upon which laser beam 104 overlaps with the same path taken after originating from laser 103. Consequently, laser beam 104 is reflected continuously towards the rhombic prism and mirrors, and back onto itself resulting in a continuous loop. Laser beam(s) 105 that are not displaced by the rhombic prism 106 towards the first mirror 108 are reflected by an additional mirror 114, and as a result, directed to travel along a path shaped similarly to a figure eight 112.

In some embodiments, laser beams 104 that are about to intersect can be lensed to a specific point of intersection. This can allow further condensing of photons to increase temperature as desired. Further, the path of laser beams 104 can be corrected or adjusted by one or more lenses on a return path and directed to one or more return mirrors. This can allow the cycle to repeat, according to some embodiments.

In some embodiments, system 100 is configured to manage efficiency leak(s) of laser beam(s) 104. System 100 can collect or reflect same to a desired intersection point, such as using one or more additional mirrors. In some embodiments, system 100 for amplifying a laser beam, includes: one laser beam per system and any efficiency leak that occurs there will be a second split beam to be collected. For example, in some embodiments, system 100 reflects a split laser originating from the laser beam through the intersection point. In some embodiments, the system further includes at least one additional mirror, each additional mirror positioned to reflect a possible efficiency leak of a reflected split beam originating from the return to the rhombic prism to the intersection point.

The center 113 of the figure eight path traveled by laser beam 104 in some embodiments is used as a site for the input of raw materials used for nuclear fusion reactions. For example, input material for fusion can be positioned at the intersection point, according to some embodiments. Raw materials may include sulfur(S), samarium (Sm), lanthanum (Lm), and/or sulfides of the two metals, such as to form francium (Fr), ununennium (element 119), and/or other elements down group one of the periodic table. Depending on the raw materials, where required, several laser sources with laser beams traveling in figure eight paths (or similar, as described) may intersect at their center points to produce high enough temperatures and pressure to support continuous nuclear fusion reactions. The continuous loop (continuous loop formed by concentrating or directing laser beams onto itself) lowers the power input used to produce the higher energy output used for nuclear fusion reactions, according to some embodiments. This can provide a more efficient and economical energy production. In some embodiments, a raw material can be any one or more of samarium, lanthanum, two moles of sulfur, or sulfur as a metal sulfide. The raw material can be adjusted as a filament is introduced continuously. Material to be formed from a fusion reaction can include one or more elements from francium to element 119 in the periodic table or, for example, down group one of the periodic table or other group of the periodic table.

In some embodiments, system 100 amplifies laser 103 and is used for nuclear fusion reactions may be used to generate sufficient amounts of energy to support space engines or power plants to generate electricity. Other user cases for system(s) 100 include power generation and/or space craft engines, for example, according to some embodiments.

FIGS. 2(a) and (b) show example infra-red (IR) and ultraviolet (UV) laser ablation of palladium (Pd) by a 1064 nm laser in system 100, according to some embodiments. FIG. 2(a) shows an example plasma induced ablation using an IR laser directed at Pd in water, according to some embodiments. As shown, electrons are produced in plasma, and shock waves are produced. Inverse bremsstrahlung occurs. FIG. 2(b) shows an example UV photo ablation using a UV laser directed at Pd in water, according to some embodiments. As shown, fragmentation and atomization occurs, according to some embodiments. Plum is present. Raw materials positioned at an intersection point of laser beam(s) 104 are an elemental mix “fuel”, in some embodiments. For example, this can include lanthanum, samarium, and two moles sulfur (e.g., either as lanthanum or samarium mixed with lanthanum sulphide and samarium sulphide to be the right molar mix for the fusion). In some examples, once the fusion has already begun to initiate this composition, this material and/or additional material can be added. For example, the material can be fused to be element 119, then an additional two moles of sulfur can be added for the next fusion reaction and so forth.

In some embodiments, a sufficient laser 103 is shot at one or more mirrors (e.g., tungsten mirrors cooled with helium) and reflects in a pattern (e.g., a FIG. 8) with a center intersection point of the pattern such that the laser 103 repeats its own path. For example, in some embodiments, laser 103 is configured to repeat its path indefinitely (or for a long period of time) where the last way back to the original source of the laser 103 is linear with it and overlaps its previous path. Laser 103 can be configured to bend in an efficient manner with a new more efficient laser beam bending technique. The repeating pattern (e.g., FIG. 8 “continuous” looping) taken by laser 103 can allow combustion of the air during cycling of laser 103, where the temperature can be configured to reach temperatures where an intersection point of the repeating pattern of laser 103 can be used for fusion and doping with elements such as Sm, La, 2 S. Such elements can be positioned (e.g., injected) for highly radioactive fusion from Francium, 119, etc. In some embodiments, more than one lasers 103 are arranged with more than one set of mirrors, each forming a repeating pattern and intersecting at one or more desired common intersection point(s). This can provide a centre intersection point that is much hotter and can become useful for fusion, analogous to a sun floating in the centre of a room, for example.

In some embodiments, the repeating pattern is shaped (e.g., as a FIG. 8 coincidentally) from the continuous or perpetual photon flow of the laser overlapping and concentrating onto itself.

The repeating pattern of one or variable amounts of individual laser amplification systems (e.g., FIG. 8 “continuous” looping), originating from laser 103 can allow initiation of fusion at intersection point during cycling and concentrating of laser 103, where the temperature can be configured to reach temperatures where an intersection point of the repeating pattern of laser 103 can be used for fusion and doping with elements such as Sm, La, 2 S, under vacuum and away from other elements. Such elements can be positioned (e.g., injected as a filament, etc.) for highly radioactive fusion, forming Francium, element 119, etc.

In some embodiments, more than one individual laser amplification system, for its intersection point of laser 103 as depicted are arranged with each system of its repeating, amplifying laser beams, intersecting at one point as a whole. This can provide a central intersection point that is much hotter and can become useful for fusion, analogous to a sun floating in the centre of a room, for example.

In some embodiments, there is provided a system configured to constrain and amplify a laser beam travelling in a straight trajectory so as to overlap the laser beam as many times as desired to concentrate it, creating an intersection point of the laser beam of higher concentrated temperature.

FIG. 3 shows a single path intermittent pulse 1,000,000 watt laser device producing a laser beam through a point that shows combustion of air from concentrating to a point.

The described implementations herein of the present disclosure are intended to be examples only. Alterations, modifications, and variations may be effected to the particular implementations without departing from the scope of the disclosure.

Certain adaptations and modifications of the present disclosure are contemplated. Therefore, the presently discussed embodiments are considered to be illustrative and not restrictive.

While the foregoing provides certain non-limiting example embodiments, it should be understood that combinations, subsets, and variations of the foregoing are contemplated.

What is claimed is:

1. A system for amplifying a laser beam, comprising:
at least one laser source configured to provide the laser beam; and
a rhombic prism configured to reflect the laser beam to a first mirror at a first angle, the first mirror configured to reflect the laser beam to a second mirror through an intersection point, the second mirror configured to reflect the laser beam to a third mirror, the third mirror configured to reflect the laser beam to the rhombic prism through the intersection point, the rhombic prism configured to reflect the laser beam to the first mirror at the angle, the laser beam reflected in a continuous pattern.

2. The system of claim 1, further comprising at least one material positioned at the intersection point for at least one fusion reaction.

3. The system of claim 2, wherein the at least one material comprises samarium, lanthanum, metal sulfide, or any combination thereof.

4. The system of claim 1, the laser beam comprising a wavelength of 1064 nanometers.

5. The system of claim 1, the laser beam having an adjustable wavelength.

6. The system of claim 1, the rhombic prism comprises a coating of dielectric silver or silver-gold.

7. The system of claim 1, the first mirror, the second mirror, and the third mirror each comprising tungsten cooled with helium, silver, dielectric silver, or silver-gold.

8. The system of claim 1, the system under a vacuum.

9. The system of claim 1, further comprising at least one additional mirror, each additional mirror positioned to reflect an efficiency leak of a split laser beam originating from the laser beam to the intersection point.

10. Two or more systems of claim 1, each laser beam configured to intersect at the intersection point.

11. A system for amplifying a laser beam, the system comprising:
a rhombic prism and at least three mirrors, each configured to reflect the laser beam in a repeating pattern through an intersection point, the intersection point having a temperature above a threshold temperature, the threshold temperature conducive for a fusion reaction.

12. The system of claim 11, wherein the repeating pattern shaped from a continuous flow of the laser beam reflecting back onto itself.

13. A method for amplifying a laser beam, the method comprising:
providing the laser beam; and
reflecting the laser beam in a repeating pattern through an intersection point, the intersection point having a temperature above a threshold temperature, the threshold temperature conducive for at least one fusion reaction.

14. The method of claim 13, further comprising positioning at least one material at the intersection point for the at least one fusion reaction.

15. The method of claim 13, the laser beam comprising a wavelength of 1064 nanometers.

16. The method of claim 13, further comprising adjusting a wavelength of the laser beam.

17. The method of claim 13, further comprising reflecting a split laser originating from the laser beam through the intersection point.

18. The method of claim 13, further comprising maintaining the system under a vacuum.

19. The method of claim 13, further comprising providing at least one additional laser beam and reflecting each of the at least one additional laser beams in an additional repeating pattern through the intersection point.

20. The method of claim 13, further comprising conducting at least one fusion reaction at the intersection point.
